(19) United States
(12) Patent Application Publication
(10) Pub. No.: US 2016/0304272 A1
(43) Pub. Date: Oct. 20, 2016

(54) CONTENT CARTRIDGE

(71) Applicant: Sunbeam Products, Inc., Boca Raton, FL (US)

(72) Inventors: David Ertur, Fort. Lauderdale, FL (US); John Harrington, Boca Raton, FL (US)

(21) Appl. No.: 15/189,206

(22) Filed: Jun. 22, 2016

Related U.S. Application Data
(60) Provisional application No. 61/816,396, filed on Apr. 26, 2013.

(51) Int. Cl. B65D 85/804; A47J 31/40

(52) U.S. Cl. CPC B65D 85/8043; A47J 31/407

(57) ABSTRACT

A content cartridge is disclosed having a base with a sterile chamber and a content chamber, where the sterile chamber has a sterile chamber opening and the content chamber has a content chamber opening. A cover is sealed to the base, covering the content chamber opening and the sterile chamber opening. A first frangible seal is provided between the cover and the base extending from the content chamber. A second frangible seal is provided between the cover and the base extending between the sterile chamber and the content chamber. When the sterile chamber is pressured with a pressurizing fluid, the pressure in the sterile chamber will increase. When the predetermined pressure is exceeded in the sterile chamber, the second frangible seal opens forming a fluid path between the sterile chamber and the content chamber. In this manner, the pressurized fluid can flow from the sterile chamber. When the predetermined pressure is exceeded in the content chamber, the first frangible seal opens forming a fluid outlet path from content chamber.

### CROSS-REFERENCE TO RELATED APPLICATION

The present invention claims priority to U.S. Provisional Application No. 61/816,396 for Content Cartridge, filed on Apr. 26. 2013, the contents of which are herein incorporated by reference in ite entirety.

### FIELD OF THE INVENTION

The invention relates to the field of content cartridges, and more particularly to a content cartridge having a sterile portion to prevent cross contamination in a content dispensing machine.

### BACKGROUND OF THE INVENTION

Content cartridges for use in beverage forming machines are known, and may include a beverage content, such as ground coffee beans, tea leaves, etc. In use, a beverage forming machine introduces a fluid into the cartridge to interact with the beverage content. A piercing needle of the machine can be used to pierce a surface of the cartridge permitting liquid to enter the cartridge and mix with the beverage content. A second piercing needle can also be used to pierce a surface of the cartridge forming an outlet, permitting the mixed liquid/content to exit the cartridge.

### SUMMARY OF THE INVENTION

The present disclosure provides a content cartridge having a base defining a content chamber, where a cover sealed to the base covers the content chamber. A first frangible seal is provided between the cover and the base extending from the content chamber. The first frangible seal is configured to open when a predetermined pressure is exceeded in the content chamber, such that a fluid outlet path is formed from the content chamber.

The content cartridge can further include a separate sterile chamber positioned adjacent to the content chamber, wherein the cover covers the sterile chamber. A second frangible seal is provided between the cover and the base extending between the sterile chamber and the content chamber. The second frangible seal is configured to open when a predetermined pressure is exceeded in the sterile chamber forming a fluid path between the sterile chamber and the content chamber.

In an exemplary use, when the sterile chamber is pressured with a pressurizing fluid, the pressure in the sterile chamber will increase. When a predetermined pressure is exceeded in the sterile chamber, the second frangible seal opens forming a fluid path between the sterile chamber and the content chamber. In this manner, the pressurized fluid can flow from the sterile chamber into the content chamber.

The pressurized fluid enters the content chamber, mixing with the contents of the content chamber, as well as increasing the pressure in the content chamber. When a predetermined pressure is exceeded in the content chamber, the first frangible seal opens forming a fluid outlet path from content chamber. In this manner, the content/pressurized fluid mixture can flow out from the content cartridge.

The content cartridge can be utilized in a content dispensing apparatus. The content dispensing apparatus includes at least a housing having a first portion defining a cartridge holder and a second portion moveable between an open position and a closed position. In the open position access is provided to the cartridge holder, allowing for a content cartridge to be inserted or removed from the cartridge holder.

In the closed position, the second portion covers the cartridge holder, and includes a fluid inlet extending through second portion and having a penetrating end. The penetrating end of the fluid inlet pierces the cover over the sterile chamber, providing a fluid path into the sterile chamber. A fluid pump is provided in fluid communication with the fluid inlet, allowing for the pumping of pressurized fluid into the sterile chamber.

The content in the content cartridge can be a liquid or powder beverage concentrate, a liquid or powder food concentrate, a pharmaceutical, chemical, or other liquid, gaseous, or powered content.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a content cartridge of the present disclosure;

FIG. 2 depicts a content cartridge of the present disclosure without an impermeable, pierceable, cover;

FIG. 3 depicts a top view of the content cartridge of FIG. 1;

FIG. 4 depicts a side view of the content cartridge of FIG. 1:

FIG. 5 depicts a back view of the content cartridge of FIG. 1;

FIG. 6 depicts a front view of the content cartridge of FIG. 1;

FIG. 7 depicts a side sectional view of the content cartridge of FIG. 1;

FIG. 8 depicts a side view of the cartridge installed in a portion of a content dispensing machine which pierces a portion of the impermeable, pierceable, cover of the content cartridge:

FIG. 9 depicts another embodiment of a content cartridge of the present disclosure;

FIG. 10 depicts a top view of the content cartridge of FIG. 9;

FIG. 11 depicts an isometric view of a fitment for use on the content cartridge of FIG. 9;

FIG. 12 depicts a front view of the fitment of FIG. 11;

FIG. 13 depicts a side sectional view of the fitment of FIG. 11;

FIG. 14 depicts a second side sectional view of the fitment of FIG. 11;

FIG. 15 depicts a side view of another embodiment of a content cartridge of the present disclosure;

FIG. 16 depicts a top view of the content cartridge of FIG. 15 without an impermeable, pierceable, cover;

FIG. 17 depicts a side view of another embodiment of a content cartridge of the present, disclosure; and

FIG. 18 depicts a top view of the content cartridge of FIG. 17 without an impermeable, pierceable, cover.

### DETAILED DESCRIPTION OF THE INVENTION

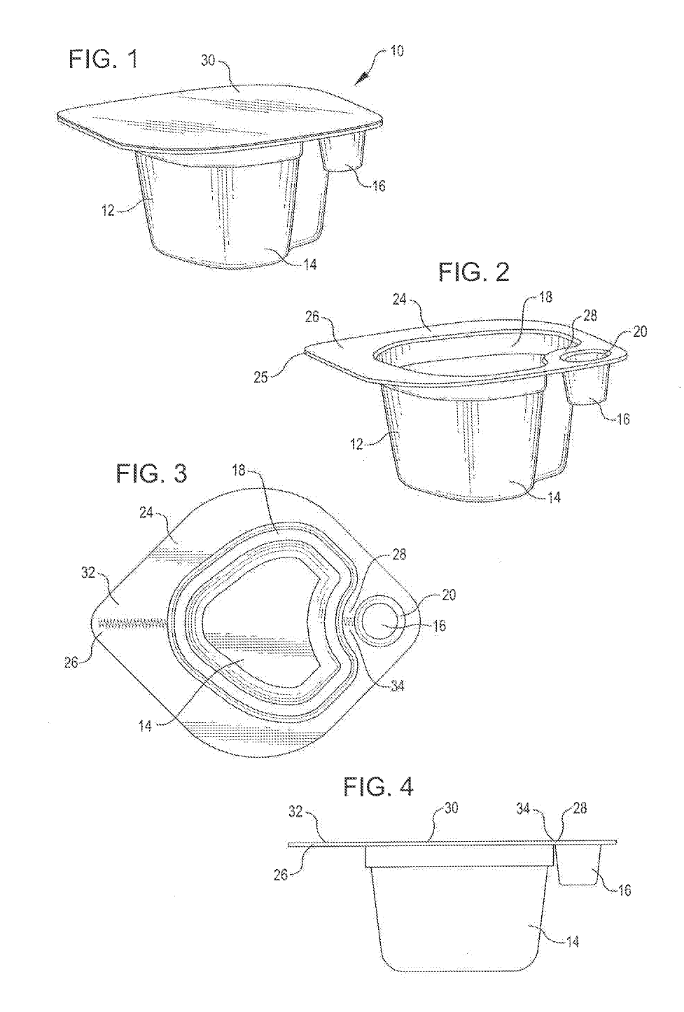

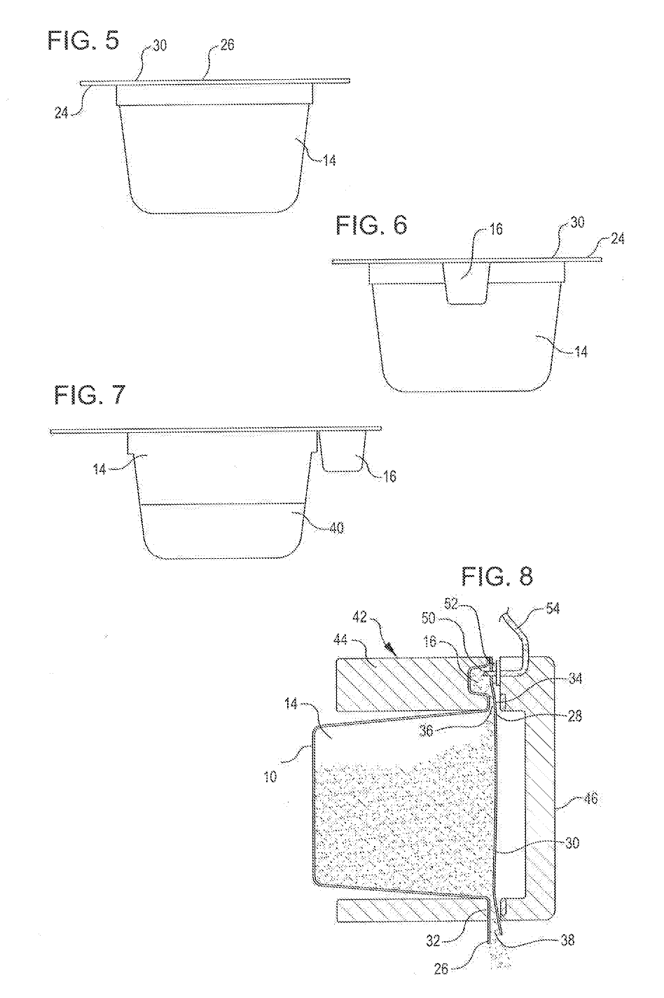

Referring now to the drawing figures in which like reference designators refer to like elements, there is shown in FIG. 1-6 an exemplary content cartridge 10 of the present disclosure. The content cartridge 10 includes an impermeable base 12 having a predetermined shape, including a content chamber 14 and a sterile chamber 16. Each of the content chamber 14 and sterile chamber 16 have openings 18 and 20 surround by a rim, lip, or flange 24 extending radially outwardly. A first end 25 of the flange 24 includes a pouring lip 26. The flange 24 further includes an intermediate portion 28, separating the content chamber 14 from the sterile chamber 16.

The base 12 can be made of a combination of polystyrene, ethylene vinyl alcohol and polyethylene.

An impermeable, pierceable, cover 30 is positioned over the openings 18 and 20 of the content chamber 14 and a sterile chamber 16, sealingly engaging the flange 24 about the content chamber 14 and the sterile chamber 16, forming a content cartridge 10 having completely separated impermeable content chamber 14 and a sterile chamber 16. The cover 30 can also be extended radially about the flange 24, engaging the pouring lip 26 and intermediate portions 28 of the flange 24.

The cover 30 can be sealed to the flange 24 using known sealing techniques, including, but not limited to, adhesives, embossing, heating sealing, and sonic welding. The sealing of the cover 30 to the flange 24 can include a frangible seal 32 extending from the content chamber 14 along the pouring lip 26, and a frangible seal 34, on the intermediate portion 28, extending between the content chamber 14 and sterile chamber 16.

Referring also to FIG. 8, frangible seal 34 is configured to open, separating the cover 30 from the flange 24 along the intermediate space 28, upon a pressurization of the sterile chamber 1, and when the pressure in the sterile chamber 16 exceeds a predetermined level. In this manner, a fluid path 36 is created between the sterile chamber 16 and the content chamber 14.

Frangible seal 32 is configured to open, separating the cover 30 from the flange 24 along the pouring lip 26, upon a pressurization of the content chamber 14 and when the pressure in the content chamber 14 exceeds a predetermined level. In this manner, a fluid output path 38 is created from the content chamber 14 along the pouring lip 26.

Referring to FIG. 7, the content chamber can include a content 40 to be dispensed from the content cartridge 10. The content 40 can be a liquid or powder beverage concentrate, a liquid or powder food concentrate, a pharmaceutical, chemical, or other liquid, gaseous, or powered, content.

Referring again to FIG. 8, the content cartridge 10 is well adapted for use in a content dispensing machine where it will be positioned in a content hold 42. The content holder 42 can include a first part 44 for supporting the base 12 of the content cartridge 10 and a second part 46 to engage the cover 30 of the content cartridge 10. The second part 46 includes a penetrator or needle 50 which penetrates a portion 52 of the cover 30 over the sterile chamber 16 to provide pressurized fluid 54 through the needle 50 in the sterile chamber 16.

The pressurized fluid 54 pressurizes the sterile chamber 16. When the pressure in the sterile chamber 16 exceeds a predetermined level the frangible seal 34 opens, separating the cover 30 from the flange 24 along the intermediate space 28. In this manner, a fluid path 36 is created between the sterile chamber 16 and the content chamber 14, allowing the pressurized fluid 54 to enter the content chamber 14.

The pressurized fluid 54 then pressurizes the content chamber 14. When the pressure in the content chamber 14 exceeds a predetermined level frangible seal 32 opens, separating the cover 30 from the flange 24 along the pouring lip 26. In this manner, a fluid output path 38 is created from the content chamber 14 along the pouring lip 26, allowing for the dispensing of the content 40 from the content chamber 14 through the fluid output path 38.

In an exemplary use, the content 40 is a beverage concentrate. The content cartridge 10 positioned the content holder 42, with the first part 44 supporting the base 12 of the content cartridge 10 and the second part 46 engaging cover 30 of the content cartridge 10. The needle 50 of the second part 46 penetrates the portion 52 of the cover 30 over the sterile chamber 16 to provide pressurized fluid 54, such as water, through the needle 50 in the sterile chamber 16.

The pressurized fluid 54 pressurizes the sterile chamber 16. When the pressure in the sterile chamber 16 exceeds a predetermined level, frangible seal 34 opens, separating the cover 30 from the flange 24 along the intermediate space 28. In this manner, a fluid path 36 is created between the sterile chamber 16 and the content chamber 14, allowing the pressurized fluid 54 to enter the content chamber 14, mixing with the beverage concentrate 40.

The pressurized fluid 54 then pressurizes the content chamber 14. When the pressure in the content chamber 14 exceeds a predetermined level, frangible seal 32 opens, separating the cover 30 from the flange 24 along the pouring lip 26. In this manner, a fluid output path 38 is created from the content chamber 14 along the pouring lip 26, allowing the fluid 54 beverage concentrate mixture 40 to be dispensed from the content chamber 14 through the fluid output path 38 into a cup or other container.

In another embodiment, the content cartridge 10 can include a fitment attached to the impermeable, pierceable, cover 30. The fitment includes a mechanism for piercing the cover 30, thus negating the need for the content dispensing apparatus to pierce that cove 30. Alternatively, the fitment can include a valve assembly, which when opened provides a fluid path into the content cartridge 10. In this manner, no element of the content dispensing apparatus conies into contact with the contents of the content cartridge 10, thus substantially preventing cross contamination by the content dispensing apparatus.

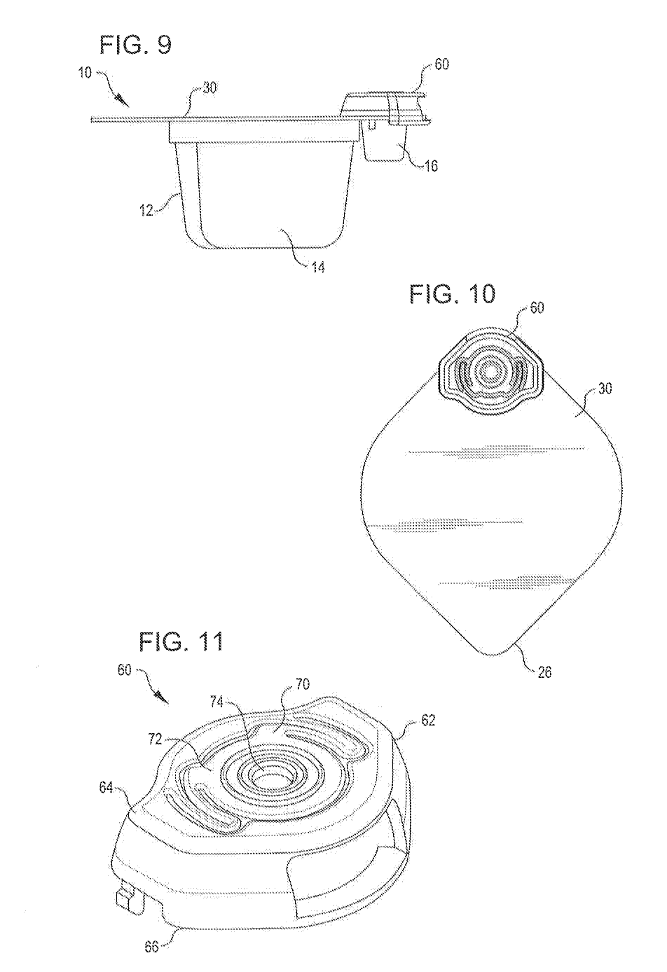

Referring to FIGs. 9-10, the fitment 60 is attached to the cover 30, positioned over the sterile chamber 16 of the content cartridge. The fitment 60 can be attached to the cover 30 with a mechanical or chemical means, or be integrated into the cover 30.

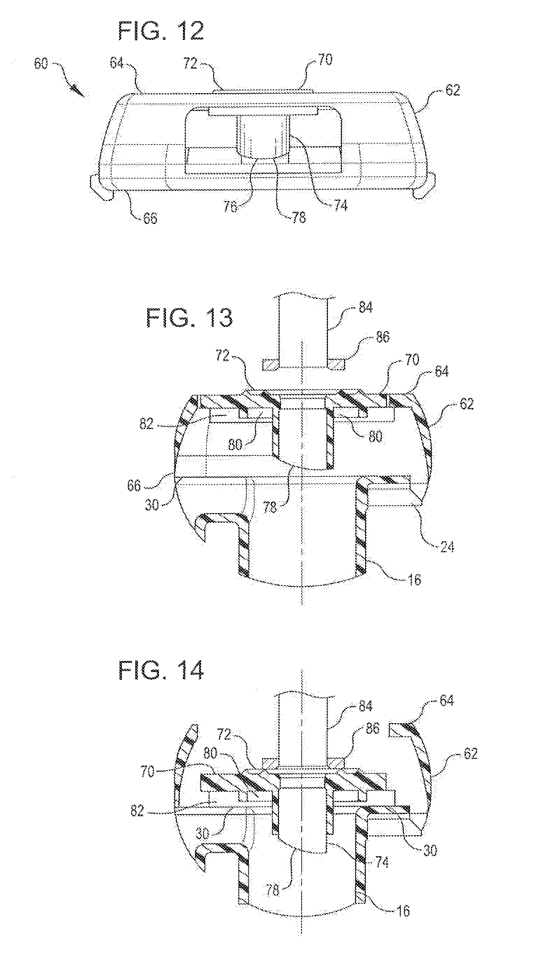

Referring to FIGs. 11-13, the fitment 60 includes a body portion 62 having upper and lower surfaces 64, 66. A center 68 of the body potion 62 includes a moveable depressive member 70. The depressive member 70 has an upper engagement surface 72 surrounding a longitudinal fluid inlet 74. A distal end 76 of the fluid inlet 74 includes a piercing member 78. A gasket 80 is positioned about the fluid inlet 74, adjacent to an underside surface 82 of the depressive member 70.

Referring to FIGs. 13 and 14, in use the fitment 60 is attached to cover 30, where the lower surface 64 of the fitment 60 is attached to the cover 30 with an adhesive or mechanical means. To dispense the contents, the content cartridge 10 is positioned in the content holder 42 of the dispensing apparatus, with the first part 44 supporting the base 12 of the content cartridge 10 and the second part 46 engaging cover 30 of the content cartridge 10. A fluid dispensing portion 84 of the content dispensing apparatus is moved into contacted with the upper engagement surface 72 of the depressive member 70, such that a fluid path is created between the fluid dispensing portion 84 and the fluid inlet 74. A gasket 86, positioned about the fluid dispensing portion 84 forms a fluid tight seal between the fluid dispensing portion 84 and the upper engagement surface 72 of the depressive member 70.

To penetrate the cover 30, the fluid dispensing portion 84 imparts a depressive force onto the upper engagement surface 72 of the depressive member 70, forcing the depressive member 70 into, through, the body portion 62 of the fitment 60. The piercing member 78 at the distal end 76 of the fluid inlet 74 pierces the cover 30, creating a fluid path into the sterile chamber 16. The depressive member 70 is pushed until the gasket 80 on the underside surface 82 of the depressive member 70, about the about fluid inlet 74, is depressed against the cover 30 forming a fluid tight seal between the cover 30 and the fluid inlet 74. Once completed, the pressurized fluid 54 can be introduced into the sterile chamber 16.

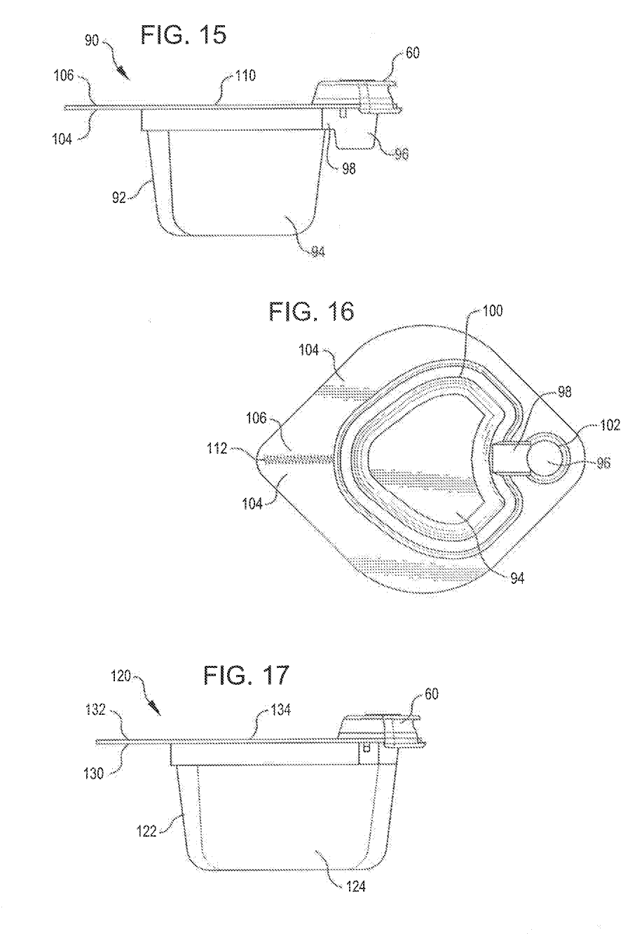

Referring to FIGs. 15-16, another exemplary content cartridge 90 of the present disclosure is provided. The content cartridge 90 includes an impermeable base 92 having a predetermined shape, including a content chamber 94 and a secondary chamber 96, where a channel 98 fluidly connects the contend chamber 94 to the secondary chamber 96. Each of the content chamber 94 and second chamber 96 have openings 100 and 102 surround by a rim, lip, or flange 104 extending radially outwardly. A first end 106 of the flange 104 includes a pouring lip 108.

An impermeable, pierceable, cover 110 is positioned over the content chamber 94, secondary chamber 96, and the channel 98, sealingly engaging the flange 104 about the content chamber 94, secondary chamber 96, and the channel 98. The cover 110 can also be extended radially about the flange 104, engaging the pouring lip 108.

The cover 110 can be sealed to the flange 104 using known sealing techniques, including, but not limited to, adhesives, embossing, heating sealing, and sonic welding. The sealing of the cover 110 to the flange 104 can include a frangible seal 112 extending from the content chamber 94 along the pouring lip 108.

The frangible seal 112 is configured to open, separating the cover 110 from the flange 104 along the pouring lip 108 upon a pressurization of the content chamber 94, when the pressure in the content chamber 94 exceeds a predetermined level. In this manner, a fluid output path is created from the content chamber 94 along the pouring lip 108.

The fitment 60 is attached to the cover 110, positioned over the secondary chamber 96 of the content cartridge 92. The fitment 60 can be attached to the cover 110 with a mechanical or chemical means, or be integrated into the cover 110. The fitment 60 operates as described above.

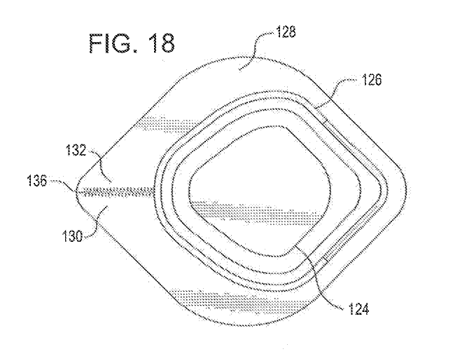

Referring to FIGs. 17-18, another exemplary content cartridge 120 of the present disclosure is provided. The content cartridge 120 includes an impermeable base 122 having a predetermined shape, including a content chamber 124 having openings 126 surround by a rim, lip, or flange 128 extending radially outwardly. A first end 130 of the flange 128 includes a pouring lip 132.

An impermeable, pierceable, cover 134 is positioned over the content chamber 124, sealingly engaging the flange 128 about the content chamber 124. The cover 134 can also be extended radially about the flange 128, engaging the pouring lip 132.

The cover 134 can be sealed to the flange 128 using known sealing techniques, including, but not limited to, adhesives, embossing, heating sealing, and sonic welding. The sealing of the cover 134 to the flange 128 can include a frangible seal 136 extending from the content chamber 124 along the pouring lip 132.

The frangible seal 136 is configured to open, separating the cover 134 from the flange 128 along the pouring lip 132 upon a pressurization of the content chamber 124, when the pressure in the content chamber 124 exceeds a predetermined level. In this manner, a fluid output path is created from the content chamber 124 along the pouring lip 132.

The fitment 60 is attached to the cover 134, positioned over the content chamber 124 of the content cartridge 120. The fitment 60 can be attached to the cover 134 with a mechanical or chemical means, or be integrated into the cover 134. The fitment 60 operates as described above.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1-14. (canceled)

15. A content dispensing apparatus comprising:
a housing defining a cartridge holder, and including a first portion and a second portion, wherein the first and second portions are moveable between an open position and a closed position, wherein in the open position access is provided to the cartridge holder and in the closed position the first and second portions seal the cartridge holder;
a fluid inlet having a fluid injection end;
a fluid pump in fluid communication with the fluid inlet;
a content cartridge including a first chamber and a second chamber adjacent to the first chamber, the content cartridge being positionable in the cartridge holder, wherein the fluid injection end of the fluid inlet pierces the second chamber when the first and second portions of the housing are in the closed position; and
a content contained in the first chamber of the content cartridge.

16. The content dispensing apparatus as set forth in claim 15, further comprising a sealing cover covering the first chamber and the sterile chamber, wherein the penetrating end of the fluid inlet pierces a portion of the sealing cover over the sterile chamber when the second portion of the housing is in the closed position.

17. The content dispensing apparatus as set forth in claim 16, wherein the content cartridge further comprising a first frangible seal between the sealing cover and the content cartridge extending from the first chamber.

18. The content dispensing apparatus as set forth in claim 17, wherein the first frangible seal opens when a predetermined pressure is exceeded in the first chamber forming an outlet path from the first chamber.

19. The content dispensing apparatus as set forth in claim 15, wherein the first chamber includes a liquid, gaseous, or powered content

20. The content dispensing apparatus as set forth in claim 15, wherein the contest first chamber includes a beverage concentrate, a food concentrate, a pharmaceutical, or a chemical.

21. The content dispensing apparatus as set forth in claim 15, wherein the content cartridge comprising;
a base including the first chamber and the second chamber, the first chamber having a first chamber opening and the second chamber having a second chamber opening; and
a cover sealed to the base, covering the first chamber opening and the second chamber opening.

22. The content dispensing apparatus as set forth in claim 21, wherein the base further comprises a flange surrounding the first chamber opening and the second chamber opening, wherein the cover is sealed to the flange.

23. The content dispensing apparatus as set forth in claim 22, wherein the flange include a pouring lip extending from the first chamber and an intermediate space extending between the second chamber and the first chamber.

24. The content dispensing apparatus as set forth in claim 23, further comprising a frangible seal between cover and the flange along the pouring lip.

25. The content dispensing apparatus as set forth in claim 24, wherein the frangible seal opens when a predetermined pressure is exceeded in the first chamber forming a fluid outlet from the content chamber along the pouring lip.

26. The content dispensing apparatus as set forth in claim 15, wherein the content cartridge comprising:
a base defining the first chamber having an opening surrounded by a rim, wherein a first end of the rim included a pouring lip;
an impermeable cover sealed to the rim surrounding the opening, covering the first chamber, wherein the cover is pierceable by the fluid inlet; and
a frangible seal formed between the cover and the first end of the rim, wherein the frangible seal opens when a first predetermined pressure is exceeded in the first chamber separating the cover from the first end of the rim forming an outlet path from the first chamber between the cover and the first end of the rim.

27. The content dispensing apparatus as set forth in claim 26, the base further defining the second chamber adjacent to the first chamber, wherein the impermeable cover covers the second chamber.

28. The content dispensing apparatus as set forth in claim 27, further comprising a second seal between the cover and the base extending between the second chamber and the first chamber.

29. The content dispensing apparatus as set forth in claim 28, wherein second seal opens when a second predetermined pressure is exceeded in the second chamber forming a path between the second chamber and the first chamber.
